(19) United States
(12) Patent Application Publication
(10) Pub. No.: US 2021/0398033 A1
(43) Pub. Date: Dec. 23, 2021

(54) TIME RENTAL FACILITY

(71) Applicant: TAISHO SKY BUILDING, INC., Tokyo (JP)

(72) Inventor: Kazuharu ISHIDA, Tokyo (JP)

(73) Assignee: TAISHO SKY BUILDING, INC.

(21) Appl. No.: 17/463,212

(22) Filed: Aug. 31, 2021

Related U.S. Application Data
(63) Continuation of application No. PCT/JP2019/008106, filed on Mar. 1, 2019.

(51) Int. Cl. G06Q 10/02; G06Q 10/10; G06Q 30/06

(52) U.S. Cl. CPC G06Q 10/02; G06Q 30/0645; G06Q 10/109

(57) ABSTRACT

A reservation system includes a management device and an accessory device. The management device includes a reservation manager that manages reservation information set by reservation, a setting input module that receives input of setting conditions for the accessory devices, a command generator that generates a command for the accessory devices based on the reservation information and the setting conditions, and a command transmitter that transmits the command to the accessory devices via a communication network. The accessory device includes a command receiver that receives the command and a command executor that executes a predetermined operation based on the command.

### RELATED APPLICATIONS

The present application is a continuation of International Patent Application No. PCT/JP2019/008106, filed Mar. 1, 2019, which is hereby incorporated by reference in its entirety.

### TECHNICAL FIELD

This disclosure relates to a reservation system for setting a usage time and reserved space to a user.

### BACKGROUND

A system for renting empty conference rooms of a building (e.g., an office, a hotel, or the like) to users typically includes a management server open to a communication network such as the Internet, and a plurality of reservation servers in which information on the conference room is stored. Such a system is typically configured so that users can access information describing the conference room in a reservation server via the management server and reserve a desired conference room. Such a system also typically has a billing function so that a rental fee can be paid online.

### SUMMARY

Since conventional reservation systems do not contact users who are using the conference room and do not prompt users to leave the room at the end of the reservation time. As such, some reservations may anticipate a time overrun and secure an extended reservation time, which causes a reduction in operational efficiency of the system.

The reservation system as described herein contacts users and improves the operational efficiency of the system by transmitting an appropriate command from a host side to an accessory device provided in a reserved space and causing the accessory device to execute the command.

The reservation system as described herein sets a usage time and reserved space to a user, and includes: a management device (also referred to herein as a host device) for managing the reservation system; and an accessory device provided in the reserved space and connected to the management device via a communication network. The management device includes: a reservation manager that manages reservation information including a rental start time and a rental end time set by a reservation; a setting input module that receives input of setting conditions for the accessory device; a command generator that generates a command for the accessory device based on the reservation information and the setting conditions; and a command transmitter that transmits the command to the accessory device via the communication network. The accessory device includes: a command receiver that receives the command from the command transmitter; and a command executor that executes a predetermined operation based on the command received by the command receiver.

According to such a configuration, the management device of the reservation system includes: the reservation manager that manages the reservation information; the setting input module that receives the input of setting conditions for the accessory device; the command generator that generates the command based on the reservation information and the setting conditions; and the command transmitter that transmits the command. The accessory device includes: the command receiver that receives the command; and the command executor that executes the predetermined operation based on the command. Thus, the accessory device reaches out (e.g., contact or send a communication) to the user who is using the system by executing the operation based on an appropriate command. Therefore, for example, when the rental end time approaches, by prompting the user to end the use, the accessory device suppresses the time overrun, set the free time until the next user's reservation to be short, and improve the operational efficiency of the system.

In some implementations, the command generator generates a notification command for notifying the rental end time based on the reservation information, and the command executor of the accessory device notifies the user of the rental end time based on the notification command.

According to such a configuration, the command generator generates the notification command for notifying the rental end time, and the command executor of the accessory device notifies the user of the rental end time. Thus, the accessory device prompts the user to end the use and appropriately suppress the time overrun.

Further, in some implementations, the reservation manager manages the reservation information including a reservation status after the rental end time, the command generator generates an extension command for notifying whether a rental time can be extended depending on the reservation status, based on the reservation information, and the command executor of the accessory device notifies the user whether the rental time can be extended based on the extension command.

According to such a configuration, the command generator generates the extension command for notifying whether the rental time can be extended depending on the reservation status, and the command executor of the accessory device notifies the user whether the rental time can be extended. Thus, the accessory device makes the user aware that the rental time can be extended if there is a vacancy in the reservation after the rental end time. On the other hand, if there is no vacancy in the reservation after the rental end time, the accessory device makes the user aware that the rental time cannot be extended.

In some implementations, the accessory device includes: an input receiver that receives an input of an application for extension from the user; and an application transmitter that transmits the application for extension to the management device via the communication network, and the management device includes an application receiver that receives the application for extension from the application transmitter, and the reservation manager changes the rental end time to update the reservation information based on the received application for extension.

According to such a configuration, the accessory device has the input receiver that receives the input of the application for extension and the application transmitter that transmits the application for extension to the management device, the management device has the application receiver that receives the application for extension, and the reservation manager changes the rental end time to update the reservation information based on the application for extension, so that an extension process based on the user's application can be performed. On the other hand, if there is no application for extension, the rental end time is not changed and the user may be notified that the rental end time is approaching as described above.

Further, in some implementations, the accessory device includes a detector that detects presence of the user in the reserved space, the management device includes a presence manager that manages presence information of the user based on detection by the detector, the command generator generates a warning command for notifying the user of a warning, when the user is present even after the rental end time based on the reservation information and the presence information, and the command executor of the accessory device notifies the user that the rental end time has passed based on the warning command.

According to such a configuration, the accessory device includes the detector that detects the presence of the user in the reserved space, the management device includes the presence manager that manages the presence information of the user, the command generator generates the warning command for notifying the user of the warning when the user is present even after the rental end time, and the command executor of the accessory device notifies the user that the rental end time has passed. Thus, the accessory device makes the user aware of the time overrun.

In some implementations, the command generator generates a detection command for detecting presence of a person in the reserved space, when the user is present even after the rental end time, and the accessory device includes a detection unit (also referred to herein as a detector) which is the command executor, and the detection unit detects an interior of the reserved space based on the detection command.

According to such a configuration, the accessory device includes the detection unit which is the command executor, the command generator of the management device generates the detection command for detecting presence of the person in the reserved space when the user is present even after the rental end time, and the detection unit detects the interior of the reserved space based on the detection command, so that the time overrun can be detected and potential conflicts with the user can be avoided.

In some implementations, the detection unit includes an image recording device that photographs the interior of the reserved space and records an image, based on the detection command.

According to such a configuration, the detection unit includes the image recording device, and the image recording device photographs the interior of the reserved space and records the image, based on the detection command, so that when the user is present even after the rental end time, the time overrun can be recorded, and potential conflicts with the user can be avoided.

Further, in some implementations, the command generator generates a billing command for notifying the user of billing based on an excess time when the user is present even after the rental end time, and the command executor of the accessory device notifies the user that the billing will be generated based on the billing command.

According to such a configuration, the command generator of the management device generates the billing command for notifying the user of the billing based on the excess time when the user is present even after the rental end time, and the command executor notifies the user that the billing will be generated based on the billing command, so that potential conflicts regarding a usage fee can be avoided.

Further, in some implementations, the accessory device includes a clock having an alarm which is the command executor, the command generator generates a time set command for setting a time corresponding to the rental end time in the alarm based on the reservation information, and the clock sets a ring time based on the time set command and sounds the alarm at the set ring time.

According to such a configuration, the accessory device includes the clock having the alarm which is the command executor, the command generator generates the time set command for setting the time corresponding to the rental end time in the alarm, and the clock sets the ring time based on the time set command and sounds the alarm at the set ring time. Thus, the accessory device clearly notifies the user of the rental end time by sounding the alarm.

Further, in some implementations, the accessory device includes either a lighting device or an air conditioner which is the command executor, the command generator generates an operation start time or an operation end time corresponding to the rental start time or the rental end time as an operation command based on the reservation information, and the accessory device starts an operation at the operation start time or ends the operation at the operation end time based on the operation command.

According to such a configuration, the accessory device includes either the lighting device or the air conditioner which is the command executor, the command generator generates the operation start time or the operation end time corresponding to the rental start time or the rental end time as the operation command, and the accessory device starts the operation at the operation start time or ends the operation at the operation end time, so that the lighting device or the air conditioner can be operated before the rental start time, and the lighting device or the air conditioner can be stopped after the rental end time.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of a reservation system in accordance with some implementations.

FIG. 2 is a block diagram illustrating a configuration of the reservation system in accordance with some implementations.

FIG. 3 is a diagram illustrating reservation information in the reservation system in accordance with some implementations.

FIG. 4 is a flowchart illustrating operations of the reservation system in accordance with some implementations.

Like reference numerals refer to corresponding parts throughout the several views of the drawings.

### DETAILED DESCRIPTION

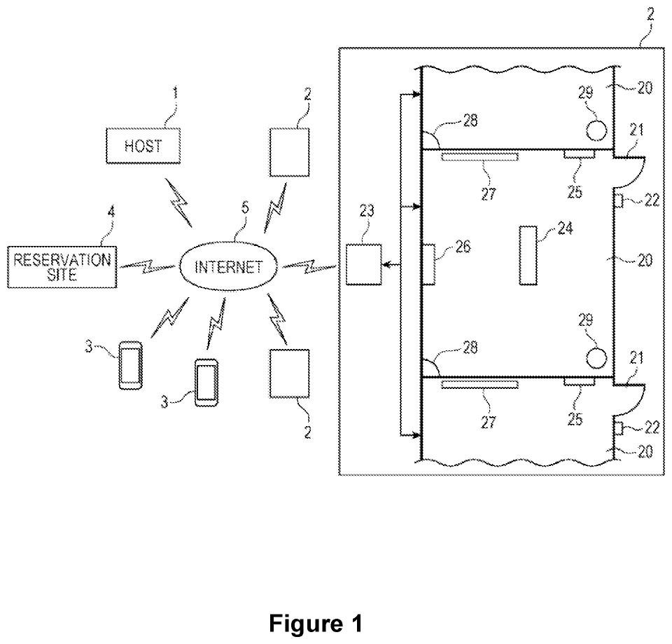

FIG. 1 is a schematic configuration diagram of a reservation system in accordance with some implementations.

As illustrated in FIG. 1, the reservation system includes a host 1 which is a management device for managing the system, and a plurality of rooms 20 which are spaces for renting (reserving) to users, and there are a plurality of buildings 2 having the plurality of rooms 20. The host 1, the buildings 2, terminal devices 3 (e.g., a mobile phone, a smart phone, or a personal computer owned by the user), and a reservation site 4 for reserving a rental of a room 20 can be connected to each other via the Internet 5 which is a public network as a communication network. The user can access the reservation site 4 via the Internet 5 using the terminal device 3, search for the room 20 in accordance with a purpose of use, and specify a usage time to perform a reservation. When the reservation site 4 receives the reservation from the user, the reservation site 4 transmits reservation information including the room 20 for which the reservation has been confirmed and a reservation time to the host 1.

The building 2 includes the rooms 20 such as a conference room and a training room, and each room 20 is provided with a doorway 21 and a locking device 22 for locking and unlocking the doorway 21. The locking device 22 can be unlocked by an authentication key such as a password or a bar code issued from the reservation site 4 to the terminal device 3 of the user, and the authentication key is randomly changed each time it is used, so that only the user who made a reservation at that time can unlock the locking device 22 by using a unique authentication key. A communication terminal device 23 such as a modem or a router is connected to each room 20 via a local area network (LAN), and accessory devices 24 to 29 provided inside each room 20 are connected to the Internet 5 via the communication terminal device 23.

The accessory devices 24 to 29 are so-called Internet of Things (IoT) devices, and by being connected to the Internet 5, various information can be transmitted between them and external devices including the host 1, and at the same time operations of the accessory devices 24 to 29 can be appropriately controlled by the host 1, and appropriate operation commands can be sent from the accessory devices 24 to 29 to the host 1. The accessory device 24 is a lighting device installed on a ceiling. The accessory device 25 is a clock provided on the wall, and the accessory device 26 is an air conditioner installed on the wall. The accessory device 27 is a display device such as a liquid crystal monitor. The accessory device 28 is a motion sensor (detection unit) provided at a corner of the wall and the ceiling. The accessory device 29 is a video camera (an image recording device that is a detection unit) that is installed on the ceiling to photograph an inside of the room 20 and record an image. Note that the room 20 may not be provided with all of the accessory devices 24 to 29, or may be provided with IoT devices other than the accessory devices 24 to 29. Further, in addition to the IoT devices such as the accessory devices 24 to 29, furniture such as desks and chairs, telephones and fax machines, printers and copiers, whiteboards and projectors, and various other devices may be provided in the room 20.

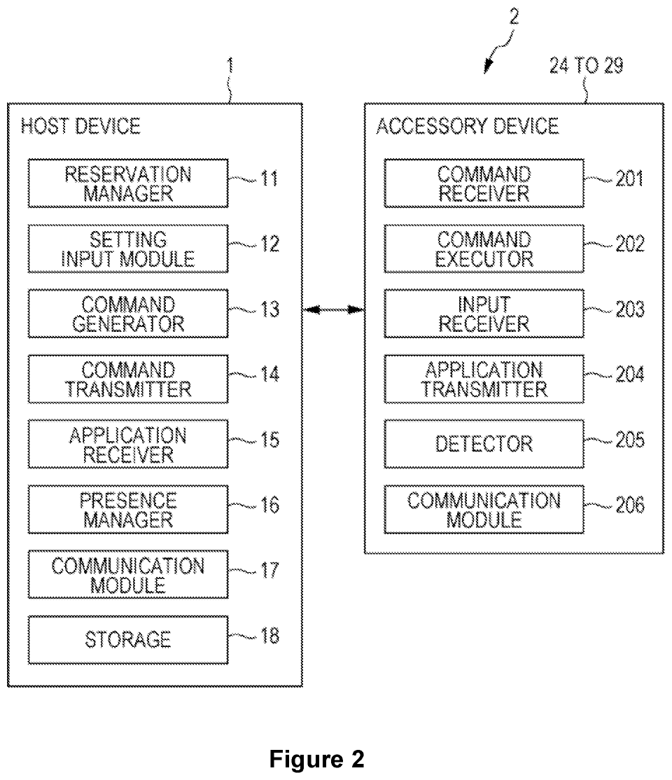

FIG. 2 is a block diagram illustrating a configuration of the reservation system.

As illustrated in FIG. 2, the reservation system includes the host 1 which is the management device and the accessory devices 24 to 29 connected to the host 1. As illustrated in FIG. 1, the host 1, the accessory devices 24 to 29, and the reservation site 4 are configured to be able to communicate with each other via the Internet 5 which is the communication network.

The host 1 includes a server device, and includes or otherwise implements a reservation manager 11 that manages the reservation information reserved by the user via the reservation site 4, a setting input module 12 that receives inputs of setting conditions (administrator settings) for the accessory devices 24 to 29 from an administrator, a command generator 13 that generates commands for the accessory devices 24 to 29 based on the reservation information, a command transmitter 14 that transmits the commands to the accessory devices 24 to 29 via the Internet 5, an application receiver 15 that receives an application from the accessory devices 24 to 29, a presence manager 16 that manages presence information of the user inside the room 20, a communication module 17 that controls communications with the accessory devices 24 to 29 and the reservation site 4, and a storage 18 (memory) that stores information such as various programs and the reservation information.

The reservation manager 11, the setting input module 12, the command generator 13, the command transmitter 14, the application receiver 15, the presence manager 16, and the communication module 17 may be executed as a program by a controller including a central processing unit (CPU) and the like provided in the server device, may be configured by independent devices, or may be configured to use cloud computing. The setting input module 12 receives the input of the administrator from an input device such as a keyboard, and stores the input setting conditions in the storage 18. As will be described below, examples of the setting conditions include timing of various notification operations to be performed for the user, billing conditions for a time overrun, and operating conditions of a prior operation, a post operation, and the like of the accessory devices 24 to 29. The storage 18 may be configured as a storage device such as a hard disk drive (HDD) or a network attached storage (NAS), or may use a storage unit of a cloud service.

The accessory devices 24 to 29 include a command receiver 201 that receives commands from the command transmitter 14 of the host 1, a command executor 202 that executes predetermined operations based on the commands received by the command receiver 201, an input receiver 203 that receives the input from the user, an application transmitter 204 that transmits the application from the user to the host 1, a detector 205 that detects presence of the user using the room 20, and a communication module 206 that controls communications with the host 1 via the communication terminal device 23 and the Internet 5. Note that the command executor 202, the input receiver 203, the application transmitter 204, and the detector 205 may be provided in all of the accessory devices 24 to 29, or may be appropriately distributed and provided in each of the accessory devices 24 to 29.

That is, the command executor 202 can use an appropriate function of the devices, such as an alarm of the accessory device (clock) 25, a screen display module of the accessory device (display device) 27, a light of the accessory device (lighting device) 24, an air conditioning operation unit of the accessory device (air conditioner) 26, a sensor of the accessory device (motion sensor) 28, and a photographing unit and a recording unit of the accessory device (video camera) 29. Further, the input receiver 203 and the application transmitter 204 can be realized by a touch operation of a screen, a button or the like of the accessory device (display device) 27. Furthermore, the detector 205 can be configured by the functions of the accessory device (motion sensor) 28 sensor and the accessory device (video camera) 29. The command receiver 201 and the communication module 206 are provided in all of the accessory devices 24 to 29, so that the command from the host 1 can be received, and the accessory devices 24 to 29 that have received the command perform the operation according to the command.

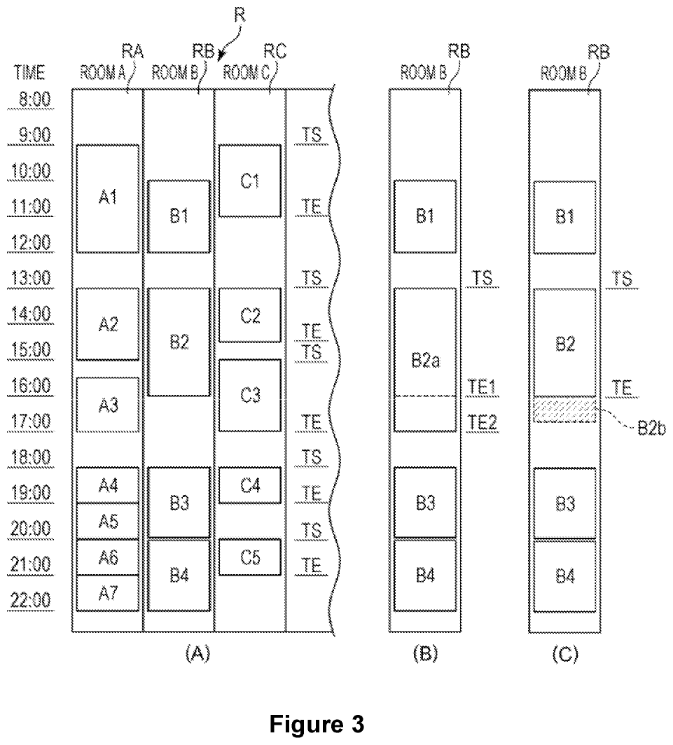

FIG. 3 is a diagram illustrating the reservation information in the reservation system.

Reservation information R is the information reserved by the user via the reservation site 4, and is stored in the storage 18 of the host 1 in association with dates and times for each room 20 of each building 2. That is, as illustrated in FIG. 3(A), a business start time (for example, 8:00) to a business end time (for example, 22:00) on a certain date for each of the rooms 20 (rooms A, B, C) and the like in a certain building is tabulated by appropriate time division (for example, in 15-minute increments), and individual reservation information A1 to A7, B1 to B4, and C1 to C5 is stored for each of reservation information RA, RB, and RC of the rooms. The individual reservation information A1 to A7, B1 to B4, and C1 to C5 is managed by the reservation manager 11, and each individual reservation information includes user information (address, name, user ID, and the like), number of users, purpose of use (meeting, seminar, entertainment, exercise, or the like), rental start time TS and rental end time TE, rental fee, and the like.

When the terminal device 3 of the user inquires about a reservation status of the room 20 to the reservation site 4, the reservation site 4 and the communication module 17 of the host 1 communicate with each other, the reservation manager 11 notifies availability of each room 20 with reference to the reservation information R of the storage 18, and the reservation site 4 causes the terminal device 3 of the user to display the availability. Specifically, as illustrated in FIG. 3(A), it is displayed on the terminal device 3 of the user that there is a vacancy between 16:00 to 18:00 in the reservation information RB of the room B and 11:00 to 13:00 in the reservation information RC of the room C, and when the user applies for a reservation for any of the rooms 20 to the reservation site 4, the reservation information is transmitted from the reservation site 4 to the host 1, and the reservation manager 11 adds a new reservation to update the reservation information R of the storage 18. Further, when reservation cancellation information from the user is transmitted to any of the individual reservation information A1 to A7, B1 to B4, and C1 to C5 via the reservation site 4, the reservation manager 11 deletes the reservation to update the reservation information R.

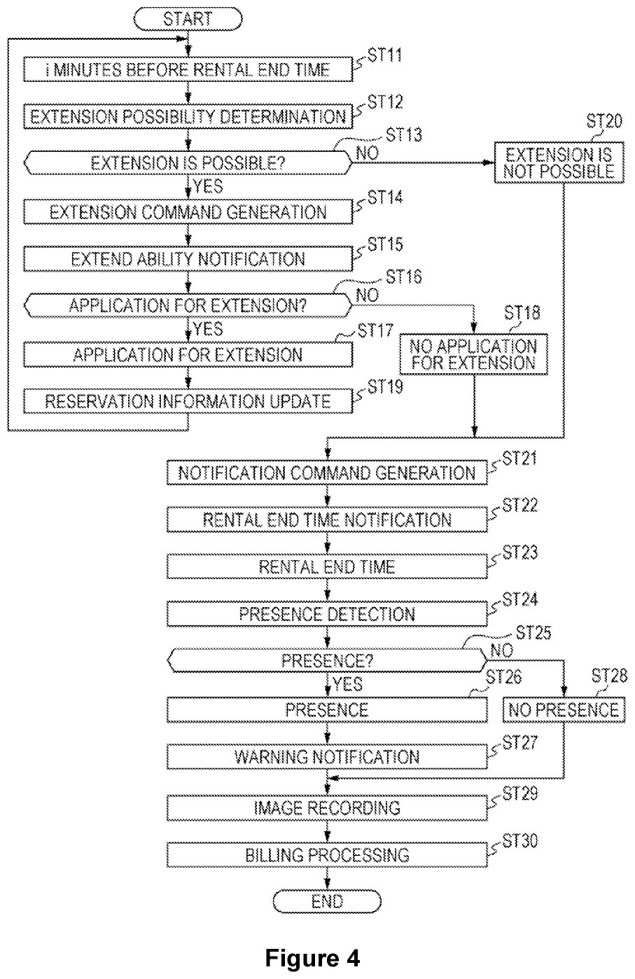

FIG. 4 is a flowchart illustrating an operation of the reservation system.

The flowchart of FIG. 4 illustrates an operation procedure of the host 1 and the accessory devices 24 to 29 after the user starts using the room 20. When the time reaches a predetermined threshold of time (i minutes) before the rental end time TE of the room 20 (an offset set by the administrator by the setting input module 12, e.g., 10 minutes) (Step ST11), the host 1 causes the reservation manager 11 to check the reservation status after the rental end time TE based on the reservation information RA, RB, and RC of the room 20. The reservation manager 11 refers to the individual reservation information A1 to A7, B1 to B4, and C1 to C5 of the storage 18, checks whether there is a vacancy for a predetermined time (for example, 30 minutes) or more after the rental end time TE, and determines whether the usage time can be extended (extension possibility determining step: Step ST12). Specifically, in the case of the individual reservation information B2 of the room B illustrated in FIG. 3(A), since there is a vacancy (on an amount of time remaining until a subsequent rental start time for a different user) of two hours after the rental end time TE (16:00), the reservation manager 11 determines that the usage time can be extended (YES in Step ST13). On the other hand, for example, in the case of the individual reservation information A4 of the room A, since there is no vacancy of a predetermined time after the rental end time TE (19:00) and before the next reservation (individual reservation information A5) is made, the reservation manager 11 determines that the usage time cannot be extended (NO in Step ST13), and proceeds to Step ST20.

When the reservation manager 11 determines that the usage time can be extended (YES in Step ST13), the command generator 13 generates an extension command for notifying whether a rental time can be extended depending on the reservation status based on the reservation information RA, RB, and RC of the rooms (extension command generation step: Step ST14). Specifically, the command generator 13 generates as a command, notification information that “the usage time can be extended” as information that the usage time can be extended, and information that “it can be extended up to two hours” as an extendable time. When such an extension command is generated, the command transmitter 14 transmits the extension command from the communication module 17 to the accessory devices 24 to 29. Out of the accessory devices 24 to 29 that have received the extension command, for example, the accessory device (display device) 27 turns on a power supply and displays on the screen the notification information that “the usage time can be extended,” “it can be extended up to two hours,” and “please apply for extension from the screen when extending,” to notify the user (extendibility notification step: Step ST15). That is, the accessory device (display device) 27 constitutes the command executor 202 that notifies the user whether an extension can be made by displaying the screen.

Further, the accessory device (display device) 27 constitutes the input receiver 203 that receives the application for extension from the user by touching the screen. When the application for extension is made (e.g., when the user operates the input receiver 203 to apply to extend the usage time), the application transmitter 204 of the accessory device 27 transmits the application for extension to the host 1 via the communication module 206. On the other hand, when the user selects not to extend the usage time by the input receiver 203 or does not operate the input receiver 203 for a certain period of time, the application transmitter 204 transmits information that the application for extension has not been made to the host 1. In the host 1, the application receiver 15 determines whether there is an application for extension from the user (Step ST16). If there is an application for extension (YES in Step ST16), the process proceeds to the next Step ST17, and if there is no application for extension (NO in Step ST16), the process proceeds to Step ST18. When there is an application for extension, the reservation manager 11 updates the reservation information R of the storage 18 (reservation information update step: Step ST19). Specifically, as illustrated in FIG. 3(A), if there is the application for extension of one hour for the individual reservation information B2 in the room B, an original rental end time TE1 (16:00) is changed to a new rental end time TE2 (17:00), depicted as individual reservation information B2a in FIG. 3(B). After updating the reservation information R by the application for extension, the process returns to Step ST11 and monitors the time until the new rental end time TE2.

When the time is i minutes before the rental end time TE (Step ST11) and the usage time cannot be extended (Step ST20) or there is no application for extension (Step ST18), the command generator 13 generates a notification command (a first notification command) for notifying the rental end time TE (notification command generation step: Step ST21). The notification command is generated as, for example, a time set command (a command to set an alarm five minutes before the rental end time TE) to the accessory device (clock having an alarm) 25 which is the command executor 202. When such a time set command is generated, the command transmitter 14 transmits the time set command from the communication module 17 to the accessory device 25. The accessory device (clock) 25 that has received the time set command, sets the ring time of the alarm to a time based on the command, and sounds the alarm when the ring time is reached, to notify the user of the rental end time TE (rental end time notification step: Step ST22). Note that a method for notifying the user of the rental end time TE is not limited to sounding the alarm of the accessory device (clock) 25, and may notify by displaying characters on the screen of the accessory device (display device) 27, or may notify by gradually dimming the light of the accessory device (lighting device) 24.

Thereafter, when the rental end time TE is reached (Step ST23) (subsequent to the rental end time TE), the presence manager 16 of the host 1 detects the user inside the room 20 by the detector 205 of the accessory device (motion sensor) 28 (presence detection step: Step ST24). The presence manager 16 manages the presence information on whether the user is present based on the detection information from the accessory device 28, and if the user is present (YES in Step ST25), the process proceeds to the next Step ST26, and if the user is not present (NO in Step ST25), the process proceeds to Step ST28. When the user is still present even if the rental end time TE is exceeded, the reservation manager 11 recognizes it as an excess time B2b that exceeds the individual reservation information B2 as illustrated in FIG. 3(C), the command generator 13 generates a warning command (a second notification command, different from the first notification command) for notifying the user that the rental end time has been exceeded, and the command transmitter 14 transmits the warning command from the communication module 17 to the accessory devices 25 and 27. The accessory device (clock) 25 sounds the alarm which is the command executor 202, and the accessory device (display device) 27 displays the characters on the screen which is the command executor 202, to notify the user that the rental end time TE has been exceeded (warning notification step: Step ST27). Note that as a method for notifying the user that the rental end time TE has been exceeded, in addition to the accessory devices 25 and 27, the light of the accessory device (lighting device) 24 may be blinked to notify the user.

Further, when the user is still present even after the rental end time TE is exceeded, the command generator 13 generates a recording command (detection command) to the accessory device (video camera) 29 for photographing the inside of the room 20 and recording the image, and at the same time generates a billing command (a third notification command) for notifying the user of billing based on the excess time B2b, and the command transmitter 14 transmits the recording command and the billing command from the communication module 17 to the accessory devices 27 and 29. The command executor 202 of the accessory device 29 photographs the inside of the room 20 based on the recording command and records the image (image recording step: Step ST29), and the command executor 202 of the accessory device 27 displays the characters on the screen based on the billing command, to notify the user that an additional charge will be generated (billing processing step: Step ST30). The warning notification step (Step ST27), the image recording step (Step ST29), and the billing processing step (Step ST30) described above are repeated until the presence of the user inside the room 20 is no longer confirmed by the accessory device (motion sensor) 28, and if the user is no longer present (Step ST28), a management process is terminated assuming that use of the room 20 has been completed. Note that the billing processing step (Step ST30) may include a billing processing in which the host 1 charges the user for a usage fee based on the amount of excess time B2b (during which the rental end time is exceeded) through the reservation site 4.

Further, in the host 1, prior to the rental start time TS, the command generator 13 generates an operation start command including an operation start time (a time set by the administrator through the setting input module 12, for example, 10 minutes before the rental start time TS) corresponding to the rental start time TS based on the reservation information R stored in the storage 18, the command transmitter 14 transmits the operation command from the communication module 17 to the accessory devices 24 to 29, and among the accessory devices 24 to 29, for example, the accessory device (lighting device) 24 which is the command executor 202, and the power supply of the accessory device (air conditioner) 26 may be turned on in advance. Further, in the host 1, the command generator 13 generates an operation end command including an operation end time corresponding to the rental end time TE, the command transmitter 14 transmits the operation command from the communication module 17 to the accessory devices 24 to 29, and the operation of the accessory devices 24 to 29 may be terminated. Further, when the use of the room 20 has been completed, the authentication key for unlocking the locking device 22 of the doorway 21 is disabled, and preparations are made according to the reservation information R of the next user.

In accordance with some embodiments, the following operations and effects can be obtained.

(1) The host 1 of the reservation system includes: the reservation manager 11 that manages the reservation information R; the setting input module 12 that receives the input of the setting conditions for the accessory devices 24 to 29; the command generator 13 that generates the command based on the reservation information R and the setting conditions; and the command transmitter 14 that transmits the command. The accessory devices 24 to 29 include: the command receiver 201 that receives the command; and the command executor 202 that executes the predetermined operation based on the command. By executing the notification operation to the user based on the received command, the accessory device reaches out (e.g., contacts or sends a communication) to the users who are using the room 20 by executing the notification based on an appropriate command. Therefore, for example, when the rental end time TE approaches, by prompting the user to end the use, the accessory device suppresses the time overrun, optimizes (e.g., shortens) free time between reservations, and improves the operational efficiency of the system.

(2) The accessory device 25 is the clock having the alarm, the command generator 13 generates the time set command for setting the time corresponding to the rental end time TE in the alarm, and the accessory device 25 sets the ring time based on the time set command and sounds the alarm at the set ring time. Thus, the accessory device clearly notifies the user of the rental end time TE by sounding the alarm.

(3) The command generator 13 generates the extension command for notifying whether the rental time can be extended depending on the reservation status based on the reservation information R, and the command executor 202 of the accessory device 27 notifies the user whether the rental time can be extended. Thus, the accessory device makes the user aware that the rental time can be extended if there is a vacancy in the reservation after the rental end time TE. On the other hand, if there is no vacancy in the reservation after the rental end time TE, the accessory device makes the user aware that the rental time cannot be extended.

(4) The accessory device 27 includes the input receiver 203 that receives the input of the application for extension, and the application transmitter 204 transmits the application for extension to the host 1. The host 1 includes the application receiver 15 that receives the application for extension, and the reservation manager 11 changes the rental end time TE to update the reservation information R based on the application for extension, so that an extension process based on the user's application can be performed.

(5) The accessory device 28 includes the detector 205 that detects the presence of the user inside the room 20, the host 1 includes the presence manager 16 that manages the presence information of the user, the command generator 13 generates the warning command for notifying the user of the warning when the user is present even after the rental end time TE, and the command executor 202 of the accessory devices 25 and 27 notifies the user that the rental end time TE has passed. Thus, the accessory device makes the user aware of the time overrun.

(6) The accessory device 29 is the video camera which is the image recording device, and when the user is present even after the rental end time TE, the command generator 13 of the host 1 generates the recording command for photographing the inside of the room 20 and recording the image, and the accessory device 29 photographs the inside of the room 20 and records the image based on the recording command, so that a status after the time overrun can be recorded and potential conflicts with the user can be avoided after the fact.

(7) The command generator 13 of the host 1 generates the billing command for notifying the user of the billing based on the excess time B2b, when the user is present even after the rental end time TE, and the command executor 202 of the accessory device 27 notifies the user that the billing will be generated based on the billing command, so that potential conflicts regarding usage fees can be avoided.

(8) The accessory devices 24 and 26 are the lighting device and the air conditioner, the command generator 13 generates the operation command including the operation start time or the operation end time corresponding to the rental start time TS or the rental end time TE, the accessory devices 24 and 26 start an operation at the operation start time or end the operation at the operation end time, so that the lighting device and the air conditioner can be operated before the rental start time TS, or the lighting device and the air conditioner can be stopped after the rental end time TE.

Note that the present disclosure is not limited to the above implementations, and modifications, improvements, and the like within the range in which the objects of the present disclosure can be achieved are included in some implementations.

For example, in the above embodiment, a rental room in which the room 20 of building 2 is rented is exemplified as the reservation system, but the reservation system is not limited to a rental room such as a conference room, and may be a rental space such as a tennis court, a baseball field, a stadium, or a parking lot, which are outdoor spaces, or a karaoke room, a rental office, a reading space, or the like.

In the above embodiment, a case where the host 1 as a management device includes the server device connected to the accessory devices 24 to 29 and to the reservation site 4 via the Internet 5 which is the communication network is exemplified, but the management device is not limited to that including such a centralized management type server device. That is, the management device may be a distributed management type device, for example, a device using a distributed transaction ledger typified by blockchain can be used, and any device that can manage the reservation information, send various commands to the accessory device, and receive and process the application from the accessory device can be used. Further, in the above embodiment, the host 1 as the management device and the reservation site 4 are separately provided and connected to each other via the Internet 5, but the present disclosure is not limited to this, and the host 1 and the reservation site 4 may be provided in a single site, or the function of the management device and the function of the reservation site may be implemented by a plurality of devices distributed across the Internet.

In the above embodiment, the command generator 13 generates the extension command for notifying whether the rental time can be extended depending on the reservation status of the room 20, and the command executor 202 of the accessory device 27 notifies the user whether the rental time can be extended, but such a function of notifying whether the rental time can be extended can be omitted. Further, in the above embodiment, the accessory device 27 includes the input receiver 203 that receives the input of the application for extension from the user and the application transmitter 204 that transmits the application for extension to the host 1, and the host 1 includes the application receiver 15 that receives the application for extension, but such a function of inputting, transmitting and receiving the application for extension can be omitted. Furthermore, the functions related to the notification and application for extension may be performed on the terminal device 3 of the user through the reservation site 4.

In the above embodiment, the command generator 13 generates the warning command for notifying the user of the warning when the user is present even after the rental end time TE, and the command executor 202 of the accessory devices 25 and 27 notifies the user that the rental end time TE has passed, but such a function of notifying the time overrun can be omitted. Further, the function of notifying the time overrun may be performed on the terminal device 3 of the user through the reservation site 4.

In the above embodiment, the command generator 13 generates the recording command (detection command) for photographing the inside of the room 20 and recording the image, when the user is present even after the rental end time TE, and the accessory device (video camera) 29 photographs the inside of the room 20 and records the image, based on the recording command, but such an image recording function can be omitted. Further, the detection unit is not limited to the image recording device (accessory device) 29 that records the image, and may be a sound recording device that records sound. Furthermore, the detection unit may be one that detects a body temperature of the user by an infrared sensor or the like, or the motion sensor (accessory device) 28, and records the detected detection information with the passage of time.

In the above embodiment, the command generator 13 generates the billing command for notifying the user of the billing based on the excess time B2b when the user is present even after the rental end time TE, and the command executor 202 of the accessory device 27 notifies the user that the billing will be generated based on the billing command, but such a billing notification function can be omitted. Further, the function of notifying the billing based on the excess time B2b may be performed on the terminal device 3 of the user through the reservation site 4.

In the above embodiment, the command generator 13 generates the operation command including the operation start time or the operation end time corresponding to the rental start time TS or the rental end time TE to the accessory devices 24 and 26 which are the lighting device and the air conditioner which is the command executor 202, and the accessory devices 24 and 26 start the operation at the operation start time or end the operation at the operation end time, but such functions of the prior operation or post-operation stop can be omitted.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A system comprising a host device including one or more processors and memory storing one or more programs to be executed by the one or more processors, the one or more programs including instructions for:
obtaining a rental start time and a rental end time for a user of a rental space;
receiving administrator settings for a first accessory device provided in the rental space, wherein the administrator settings include a predetermined threshold of time before the rental end time for the rental space;
upon reaching the predetermined threshold of time before the rental end time:
generating a first notification command instructing the first accessory device to notify the user of the rental end time; and
transmitting the first notification command to the first accessory device via a communication network;
upon reaching the rental end time:
receiving presence information from a second accessory device provided in the rental space via the communication network, wherein the presence information indicates that the user is present in the rental space; and
determining, based on the rental end time and the presence information, that the rental end time is exceeded; and
in accordance with the determination that the rental end time is exceeded, generating:
generating a second notification command, different from the first notification command, instructing the first accessory device to notify the user that the rental end time has been exceeded;
transmitting the second notification command to the first accessory device via the communication network;
generating a recording command instructing the second accessory device or a third accessory device to record an image of the rental space;
transmitting the recording command to the second accessory device or to the third accessory device via the communication network; and
charging the user a usage fee based on an amount of excess time during which the rental end time is exceeded.

2. The system of claim 1, wherein the one or more programs further include instructions for:
upon reaching the predetermined threshold of time before the rental end time, determining whether an extension of the rental end time for the user is possible based on an amount of time remaining until a subsequent rental start time for a different user;
wherein generating the first notification command is further in accordance with a determination that the extension of the rental end time for the user is not possible.

3. The system of claim 1, wherein the one or more programs further include instructions for:
upon reaching the predetermined threshold of time before the rental end time, determining whether an application for extension has been received from the first accessory device based on the first accessory device receiving input indicating the user is applying for an extension of the rental end time;
wherein generating the first notification command is further in accordance with a determination that the application for extension has not been received from the first accessory device.

4. The system of claim 1, wherein the one or more programs further include instructions for:
in accordance with the determination that the rental end time is exceeded:
generating a third notification command instructing the first accessory device to notify the user of the usage fee based on the amount of excess time during which the rental end time is exceeded; and
transmitting the third notification command to the first accessory device via the communication network.

5. The system of claim 1, wherein the instructions for receiving presence information from the second accessory device include instructions for receiving image-based data or audio-based data from an image recording device or from a sound recording device.

6. The system of claim 1, wherein the instructions for receiving presence information from the second accessory device include instructions for receiving temperature-based data or motion-based data from an infrared sensor or from a motion sensor.

7. The system of claim 1, wherein the one or more programs further include instructions for:
generating an operation start command instructing a fourth accessory device to turn on in advance of the rental start time; and
transmitting the operation start command to the fourth accessory device via the communication network;
wherein the fourth accessory device is a lighting device or an air conditioner provided in the rental space.

8. The system of claim 1, wherein the one or more programs further include instructions for:
generating an operation end command instructing a fourth accessory device to turn off at a time corresponding to the rental end time; and
transmitting the operation end command to the fourth accessory device via the communication network;
wherein the fourth accessory device is a lighting device or an air conditioner provided in the rental space.

9. A method, comprising:
obtaining a rental start time and a rental end time for a user of a rental space;
receiving administrator settings for a first accessory device provided in the rental space, wherein the administrator settings include a predetermined threshold of time before the rental end time for the rental space;
upon reaching the predetermined threshold of time before the rental end time:
generating a first notification command instructing the first accessory device to notify the user of the rental end time; and
transmitting the first notification command to the first accessory device via a communication network;
upon reaching the rental end time:
receiving presence information from a second accessory device provided in the rental space via the communication network, wherein the presence information indicates that the user is present in the rental space; and
determining, based on the rental end time and the presence information, that the rental end time is exceeded; and
in accordance with the determination that the rental end time is exceeded, generating:
generating a second notification command, different from the first notification command, instructing the first accessory device to notify the user that the rental end time has been exceeded;
transmitting the second notification command to the first accessory device via the communication network;
generating a recording command instructing the second accessory device or a third accessory device to record an image of the rental space;
transmitting the recording command to the second accessory device or to the third accessory device via the communication network; and
charging the user a usage fee based on an amount of excess time during which the rental end time is exceeded.

10. The method of claim 9, further comprising:
upon reaching the predetermined threshold of time before the rental end time, determining whether an extension of the rental end time for the user is possible based on an amount of time remaining until a subsequent rental start time for a different user;
wherein generating the first notification command is further in accordance with a determination that the extension of the rental end time for the user is not possible.

11. The method of claim 9, further comprising:
upon reaching the predetermined threshold of time before the rental end time, determining whether an application for extension has been received from the first accessory device based on the first accessory device receiving input indicating the user is applying for an extension of the rental end time;
wherein generating the first notification command is further in accordance with a determination that the application for extension has not been received from the first accessory device.

12. The method of claim 9, further comprising:
in accordance with the determination that the rental end time is exceeded:
generating a third notification command instructing the first accessory device to notify the user of the usage fee based on the amount of excess time during which the rental end time is exceeded; and
transmitting the third notification command to the first accessory device via the communication network.

13. The method of claim 9, wherein receiving presence information from the second accessory device includes receiving image-based data or audio-based data from an image recording device or from a sound recording device.

14. The method of claim 9, wherein receiving presence information from the second accessory device includes receiving temperature-based data or motion-based data from an infrared sensor or from a motion sensor.

15. The method of claim 9, further comprising:
generating an operation start command instructing a fourth accessory device to turn on in advance of the rental start time; and
transmitting the operation start command to the fourth accessory device via the communication network;
wherein the fourth accessory device is a lighting device or an air conditioner provided in the rental space.

16. The method of claim 9, further comprising:
generating an operation end command instructing a fourth accessory device to turn off at a time corresponding to the rental end time; and
transmitting the operation end command to the fourth accessory device via the communication network;
wherein the fourth accessory device is a lighting device or an air conditioner provided in the rental space.

17. A system comprising a host device including one or more processors and memory storing one or more programs to be executed by the one or more processors, the one or more programs including instructions for:
obtaining a rental start time and a rental end time for a user of a rental space;
receiving administrator settings, include a predetermined threshold of time before the rental end time for the rental space;
upon reaching the predetermined threshold of time before the rental end time:
generating a first notification command instructing a display device provided in the rental space to notify the user of the rental end time; and
transmitting the first notification command to the display device via a communication network;
upon reaching the rental end time:
receiving presence information from a camera or motion sensor provided in the rental space via the communication network, wherein the presence information indicates that the user is present in the rental space; and
determining, based on the rental end time and the presence information, that the rental end time is exceeded; and
in accordance with the determination that the rental end time is exceeded, generating:
generating a second notification command, different from the first notification command, instructing the display device to notify the user that the rental end time has been exceeded;
transmitting the second notification command to the display device via the communication network;
generating a recording command instructing the motion sensor or the camera to record presence information of the rental space;
transmitting the recording command to the motion sensor or to the camera via the communication network; and
charging the user a usage fee based on an amount of excess time during which the rental end time is exceeded.

18. The system of claim 17, wherein the one or more programs further include instructions for:
upon reaching the predetermined threshold of time before the rental end time, determining whether an extension of the rental end time for the user is possible based on an amount of time remaining until a subsequent rental start time for a different user;
wherein generating the first notification command is further in accordance with a determination that the extension of the rental end time for the user is not possible.

19. The system of claim 17, wherein the one or more programs further include instructions for:
upon reaching the predetermined threshold of time before the rental end time, determining whether an application for extension has been received from the display device based on the display device receiving input indicating the user is applying for an extension of the rental end time;
wherein generating the first notification command is further in accordance with a determination that the application for extension has not been received from the display device.

20. The system of claim 17, wherein the one or more programs further include instructions for:
in accordance with the determination that the rental end time is exceeded:
generating a third notification command instructing the display device to notify the user of the usage fee based on the amount of excess time during which the rental end time is exceeded; and
transmitting the third notification command to the display device via the communication network.
